(19) United States
(12) Patent Application Publication
(10) Pub. No.: US 2008/0215721 A1
(43) Pub. Date: Sep. 4, 2008

(54) COMMUNICATION MONITORING SYSTEM, COMMUNICATION MONITORING APPARATUS AND COMMUNICATION CONTROL APPARATUS

(75) Inventors: Kazunori Saito, Osaka (JP); Hiroki Nogawa, Chiba (JP); Toshio Kobayashi, Hyogo (JP); Seiji Moriya, Osaka (JP)

Correspondence Address: DARBY & DARBY P.C., P.O. BOX 770, Church Street Station, New York, NY, 10008-0770, US

(73) Assignee: SecureWare Inc., Osaka (JP)

(21) Appl. No.: 11/966,032

(22) Filed: Dec. 28, 2007

(30) Foreign Application Priority Data
Dec. 28, 2006 (JP) 2006-356062

(51) Int. Cl. G06F 15/173

(52) U.S. Cl. 709/224

(57) ABSTRACT

A communication monitoring apparatus for monitoring communication data which are transmitted among a plurality of nodes on a network, includes a detecting section for detecting whether or not a shellcode is included in communication data transmitted and received between at least two nodes within the plurality of nodes and a storing section for storing communication data transmitted from the two nodes as being starting points during a predetermined time, when the detecting section detected the shellcode in communication data.

### CROSS-REFERENCE TO RELATED APPLICATIONS

This Nonprovisional application claims priority under 35 U.S.C. §119(a) on Patent Application No. 2006-356062 filed in Japan on Dec. 28, 2006, the entire contents of which are hereby incorporated by reference.

### BACKGROUND

1. Technical Field

The present application relates to a communication monitoring system, a communication monitoring apparatus and a communication control apparatus for monitoring an operation of malicious softwares.

2. Description of the Related Art

Recently, a botnet is a serious threat for an internet (for example, see page 66 to 77 in Aug. 14, 2006 issue of NIKKEI PERSONAL COMPUTING). The botnet is a network constructed from an attacker, a control server and a lot of infected computers with the bot. A bot is a malicious program, and has a infection function to other computer and a updating function of the program. The infected computers with the bot performs the DoS attack to other computers, transmission of the SPAM mail, and the collecting action of information by the spyware function i.e. keylogger.

There are some infection method of bot, that are a method using a vulnerability of OS (Operating System) or application software, a method using backdoor opened by the other computer virus, and a method of dictionary attack for a password. When attacking a vulnerability of OS or application software, the attacker limits the computer to be infected, and performs a local attack in many case. Furthermore, just after the infection, the destination of the attack is determined according to the IP address of infected computer. In this case, the computers in the segment could be the targets of the attack, when using private addresses.

It is very difficult to detect and combat such a bot by the conventional antivirus softwares using pattern files (description files). Concerning the virus or worm, it can be created description files for the measures by analyzing programs and predicting operations or threats. The botnet exists in latent form and actives at any time and at any pattern, because the botnet is operated by a human manipulation. And also, the source code of the bot is distributed in large quantity, and there exist many subspecies of the bot. Therefore, no longer sufficient measures are created under present circumstances.

Furthermore, the botnet is used as means for creating wealth. Therefore the botnet is performed enough maintenance and upgrade so as to create more economic value. Consequently, there is a trend to more and more difficult to detect and combat the bot and growing into a serious problem.

### SUMMARY

The present application has been made in view of the foregoing problems and its object is to provide a communication monitoring system, communication monitoring apparatus and communication control apparatus capable of detecting whether or not a shellcode is included in communication data transmitted and received between the two nodes on the network, and storing communication data transmitted from the two nodes as being starting points during a predetermined time, when the detecting the shellcode, whereby it is possible to detect the early communications in the infection action, and monitoring the activity of the malicious software proceeding with the infection.

A communication monitoring system according to the present application comprising a first communication monitoring apparatus; and a second communication monitoring apparatus; wherein said first communication monitoring apparatus comprising: a detecting section for detecting whether or not a shellcode is included in communication data transmitted and received between at least two nodes within the plurality of nodes; a storing section for storing communication data transmitted from the two nodes as being starting points during a predetermined time, when the detecting section detected the shellcode in communication data; and a notifying section for notifying information about communication data stored in the storing section to outside; said second communication monitoring apparatus comprising: a receiving section for receiving a notification transmitted from said first communication monitoring apparatus; a determining section for determining whether or not it is necessary to control communications between the two nodes based on the received notification.

The communication monitoring system according to the present application, wherein the information about communication data includes information about the source of the communication data.

The communication monitoring system according to the present application, wherein said second communication monitoring section further comprising a measuring block for measuring a connection frequency between the two nodes; wherein the determining section determines that it is necessary to control communications between the two nodes, when the measured connection frequency is high.

A communication monitoring apparatus according to the present application comprising a detecting section for detecting whether or not a shellcode is included in communication data transmitted and received between at least two nodes within the plurality of nodes; and a storing section for storing communication data transmitted from the two nodes as being starting points during a predetermined time, when the detecting section detected the shellcode in communication data.

A communication control apparatus according to the present application comprising a receiving section for receiving information about communications transmitted from a source or a destination of communication data including a shellcode; a determining section for determining whether or not it is necessary to control communications between the source and the destination based on the received information; and a controller capable of controlling communications between the source and the destination, when the determining section determines that it is necessary to control communications.

The communication control apparatus according to the present application further comprising a measuring block for measuring a connection frequency between the source and the destination; wherein the determining section determines that it is necessary to control communications between the source and destination, when the measured connection frequency is high.

When the bot performs infection activity, the bot uses a vulnerability of OS similar to the worm. In the infection using the security hole, after the acquisition of the control with data using security hole, a small computer-dependent language (a shellcode) to be executed at first is transmitted. In this application, the detecting section for detecting the shellcode is provided, whereby it is possible to detect the early communications in the infection action, and monitoring the activity of the malicious software proceeding with the infection.

Furthermore, in this application, it is possible to detect the executable codes involved in the bot when the executable codes involved in the bot is transmitted just after the infection. And also, the source of the shellcode is infected with the bot with a high probability and the destination of the shellcode should be infected in the bot. Therefore, it is possible to monitor the selected hosts which should be infected with the bot and detect the bot with a high probability.

According to the present application, the detecting section for detecting the shellcode and the storing section for storing the communications after the detection of the bot are provided, whereby it is possible to detect the early communications in the infection action, and monitoring the activity of the malicious software proceeding with the infection.

Also, even when the source of the shellcode is not infected with the bot, the communications including the shellcode should be communications for a takeover the system, the malicious software is operated in the source with a high probability. In the present application, it is possible to monitor the activities of malicious softwares and attackers by monitoring and storing the communications transmitted from the source or the destinations of the shellcode.

Furthermore, according to the present application, it is possible to detect the executable codes involved in the bot when the executable codes involved in the bot is transmitted just after the infection. And also, the source of the shellcode is infected with the bot with a high probability and the destination of the shellcode should be infected in the bot. Therefore, it is possible to monitor the selected hosts which should be infected with the bot and detect the bot with a high probability.

The above and further objects and features of the application will more fully be apparent from the following detailed description with accompanying drawings.

### BRIEF DESCRIPTION OF THE SEVERAL VIEWS OF THE DRAWINGS

FIG. 1 is an explanatory view explaining a schematic structure of a botnet;

FIG. 2 is an explanatory view explaining an example of the attack by the botnet;

FIG. 3 is an explanatory view explaining an example of the attack by the botnet;

FIG. 4 is an explanatory view explaining an example of the attack by the botnet;

FIG. 5 is an explanatory view explaining a structure of a communication monitoring system using communication monitoring apparatuses;

FIG. 6 is a block diagram explaining the internal structure of the communication monitoring apparatus;

FIG. 7 is a flow chart showing the procedure of a process performed by the communication monitoring apparatus; and

FIG. 8 is an explanatory view explaining a schematic structure of a communication monitoring system according to the second embodiment.

### DETAILED DESCRIPTION

The present invention will be described below specifically on the basis of the drawings showing the embodiments thereof.

### Embodiment 1

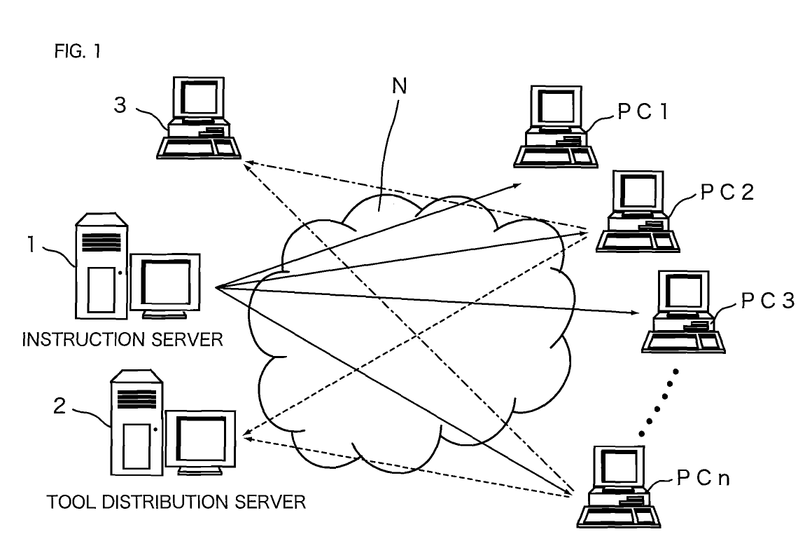

FIG. 1 is an explanatory view explaining a schematic structure of a botnet. There are a lot of hosts on an internet N. One of the hosts (or a plurality of the hosts) becomes an instruction server 1 for transmitting a shellcode. The instruction server 1 transmits the shellcode to information processing apparatuses PC1, PC2, PC3, . . . , PCn as being other hosts. The hosts (for example, the information processing apparatuses PC2 and PCn in FIG. 1) which execute the shellcode obtain a tool or the executable codes involved in the bot from a tool distribution server 2.

The information processing apparatuses PC2 and PCn which obtain the tool and the the executable codes involved in the bot (i.e. infected with the bot) attempt a DoS attack or transmission of spam.

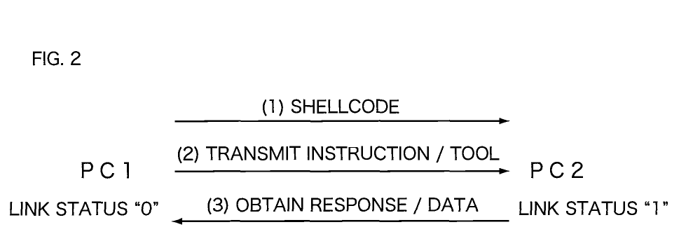

FIG. 2 to FIG. 4 are explanatory views explaining examples of the attack by the botnet. FIG. 2 shows an example of the attack between two nodes (for example, the information processing apparatuses PC1 and PC2) on a network. In this example, the attacker (the information processing apparatus PC1) obtains defired information from the information processing apparatus PC2 in accordance with the transmission of the shellcode and the instruction or the tool to the information processing apparatus PC2 and the execution of the tool in the information processing apparatus PC2.

When a definition for link status from the source of the shellcode is given, the link status of the source (the information processing apparatus PC1) can be defined as “0” and that of the destination (the information processing apparatus PC2) can be defined as “1”. In this embodiment, the operations of the attacker are estimated by monitoring relatively high traffic communications and detecting the direction and the sequence of the communications between the hosts in consideration of the link status.

For example, when the communications are carried out continuously between the host (the information processing apparatus PC1) having the link status of “0” and the host (the information processing apparatus PC2) having the link status of “1”, especially when the high traffic communications are carried out from the host having link status of “1” to the host having link status of “0”, or when a lot of hosts having link status of “1” exist on the network, it can be determined that the host having the link status of “1” will be infected with the bot with a high probability.

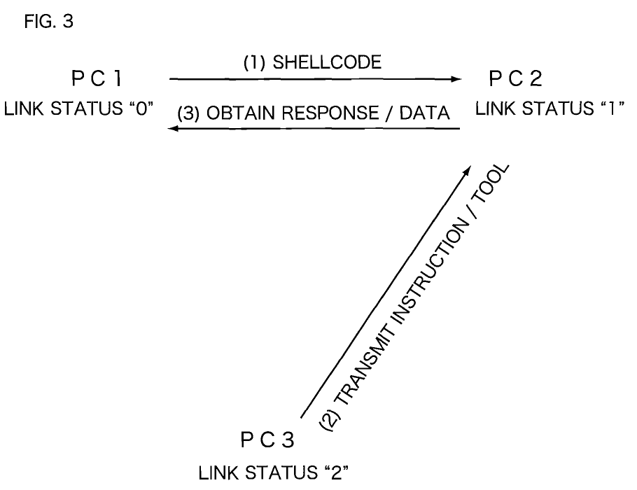

FIG. 3 shows an example of the attack established among three nodes (for example, the information processing apparatuses PC1, PC2, PC3). In this example, the shellcode is transmitted from the information processing appratus PC1 to the information processing apparatus PC2, and the instruction and the tool are transmitted from the information processing apparatus PC3 to the information processing apparatus PC2. And then, the information processing apparatus PC1 (the attacker) obtains the desired information in accordance with the execution of the tool in the information processing apparatus PC2.

Similarly, when a definition for link status from the source of the shellcode is given, the link status of the source (the information processing apparatus PC1) can be defined as “0”, that of the destination (the information processing apparatus PC2) can be defined as “1” and that of the source node for the instruction and the tool (the information processing apparatus PC3) can be defined as

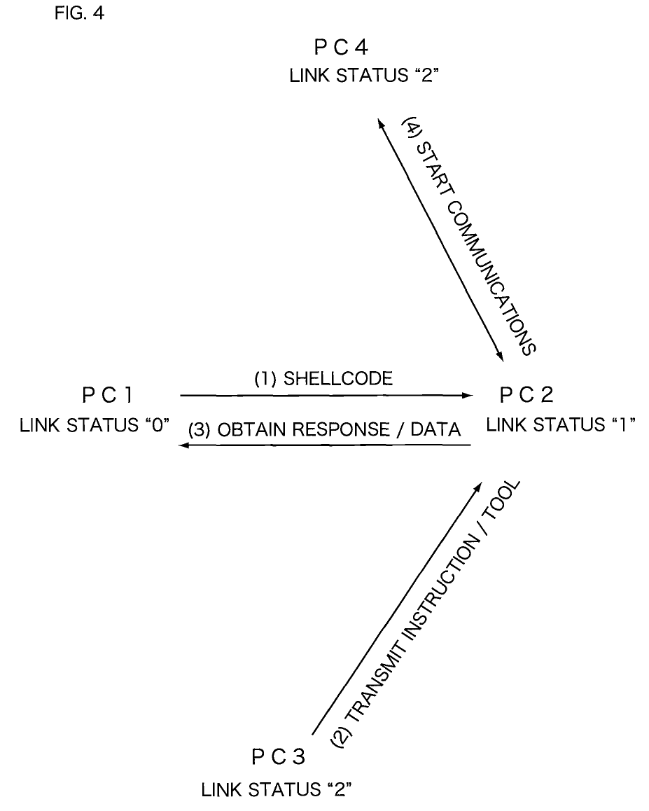

FIG. 4 shows an example of the attack established among four nodes (for example, the information processing apparatuses PC1 to PC4). In this example, the shellcode is transmitted from the information processing appratus PC1 to the information processing apparatus PC2, and the instruction and the tool are transmitted from the information processing apparatus PC3 to the information processing apparatus PC2. And then, the information processing apparatus PC1 (the attacker) obtains the desired information in accordance with the execution of the tool in the information processing apparatus PC2. Additionally, the communications are started between the information processing apparatus PC1 and the other information processing apparatus PC4, and the DoS attack, the transmission of SPAM and the like are performed.

In this embodiment, the monitoring of the communications is also tightened when there is a host having the link status of “2” or more with the potential for participation in the attack, and the operations of the attacker are estimated by monitoring a relatively high traffic communications and detecting the direction and the sequence of the communications between the hosts in consideration of the link status.

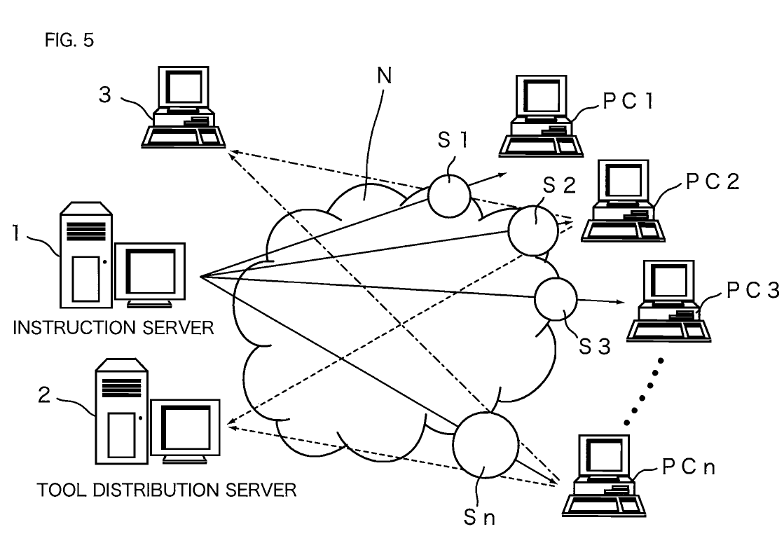

Therefore, in this embodiment communication monitoring apparatuses (S1, S2, . . . , Sn) are provided on communication pathways of the internet N for monitoring the communications and detecting the attack action described above. FIG. 5 is an explanatory view explaining a structure of a communication monitoring system using communication monitoring apparatuses S1, S2, . . . , S5. For example, the communication monitoring apparatus S1 is provided on a communication pathway so as to monitoring the communications between the instruction server 1 which transmits the shellcode and the instruction and the information processing apparatus PC1. The communication monitoring apparatuses S2, S3, . . . , Sn are provided in a like manner.

Further more, it is of course not necessary to monitoring communications between one apparatus and the other apparatus by the communication monitoring apparatuses S1 to Sn.

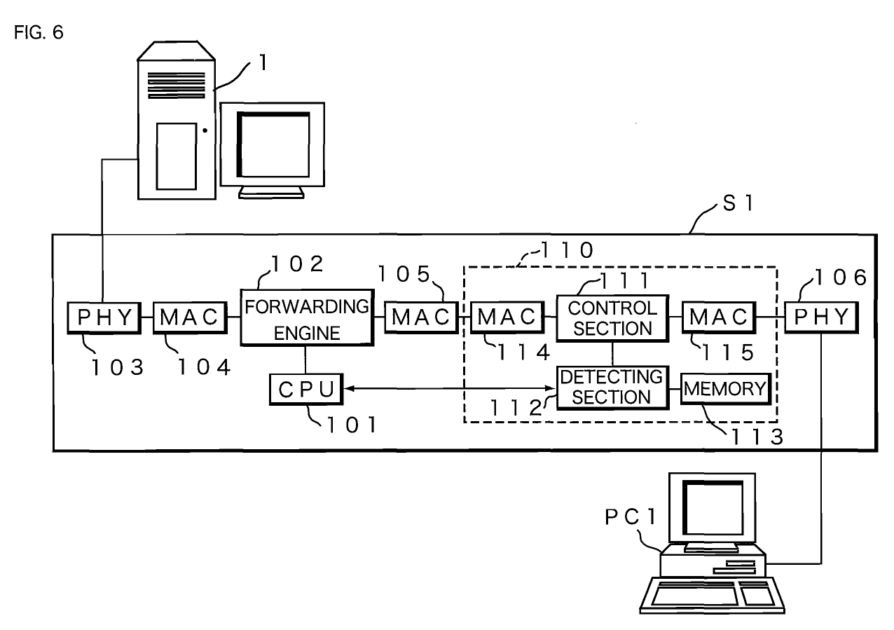

FIG. 6 is a block diagram explaining the internal structure of the communication monitoring apparatus S1. The communication monitoring apparatus S1 comprises a CPU 101, a forwarding engine 102, a PHY 103 and a MAC 104 which are connected to one communication apparatus (for example, the instruction server 1), and PHY 106 and MAC 105 which are connected to other communication apparatus (for example, the information processing apparatus PC1). Further, although one set of PHY and MAC is provided for each of the input and the output in FIG. 6, two or more sets of PHY and MAC may be provided for the input or the output.

The CPU 101 sets an optimal communication pathway after the check of received communication data, and notifies setting information to the forwarding engine 102. The forwarding engine 102 decides a destination of the received communication data based on the notification from the CPU 101 and header information of the received information.

When receiving communication data, the communication monitoring apparatus S1 monitors the communication data by the communication monitoring section 110 which are inserted by the in-line arrangement The communication monitoring section 110 are inserted between MAC 105 and PHY 106 and comprises a control section 111, a detecting section 112, a memory 113, and MAC 114, 115.

The control section 111 extract data by predetermined unit from inputted communication data in MAC 114 or 115, and deliver the extracted data to the detecting section 112. When the shellcode is detected in the data by the detecting section 112, the control section 111 store communication data during a predetermined time on the memory 113 and monitors communications, the communication data is transmitted from the source or the destination of the shellcode as being starting point. In FIG. 6, the instruction server 1 is the source of the shellcode and the information processing apparatus PC1 is the destination of the shellcode.

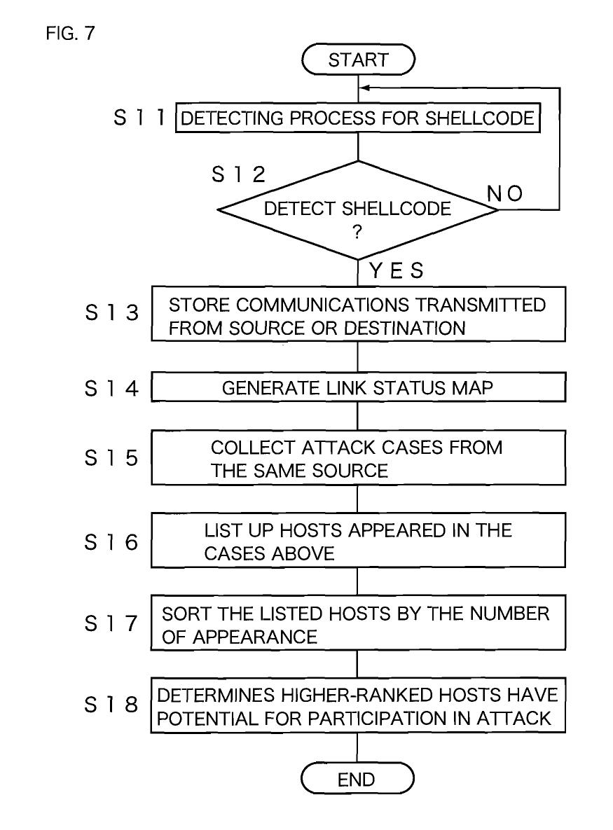

FIG. 7 is a flow chart showing the procedure of a process performed by the communication monitoring apparatus S1. At first, the communication monitoring apparatus S1 performs the detecting process of the shellcode based on the received communication data in PHY 103 or PHY 16 (Step S11). The method for data processing and the method for determining illegal process disclosed by the inventors of this application in the patent applications of PCT/JP2003/09894, PCT/JP2004/002319 and PCT/JP2004/02310 should be used for the method of detecting the shellcode. In these patent applications, the methods of detecting the shellcode, which activates or controls a program according to the attacker, as an illegal code are disclosed. It is possible to detect the shellcode from communication data in real time by using these methods.

Next, the communication monitoring apparatus S1 determines whether or not the shellcode is detected in Step S11 (Step S12). When determining that the shellconde is not detected (S12: NO), the process returns to Step S11.

When determining that the shellcode is detected (S12: YES), the source of the shellcode is infected with the bot with a high probability and the destination of the shellcode should be infected in the bot. The communication data transmitted from the source or the destination of the shellcode as being starting point is stored on the memory 113 during a predetermined time so as to tighten the monitoring of the following communications (Step S13).

Next, the control section 111 generates a link status map based on the communication data stored on the memory 113 (Step S14), the attack cases from the same source are collected (Step S15).

Next, the control section 111 lists the hosts appeared in the cases above (Step S16) and sorts the listed hosts by the number of appearance (Step S17). The control section 111 determines that the higher-ranked hosts have the potential for participation in the attack (Step S18).

Although the explanation is given only to the communication monitoring apparatus S1 in FIGS. 6 and 7, the communication monitoring apparatus S2, S3, . . . , Sn also detects the shellcode and the hosts with the potential for participation in the attack in an analogous method.

In this embodiment, the first step of the series of the attack operations is detected in accordance with the detection of the shellcode. Further, it is possible to identify the hosts related to the attack with the clue of the source and destination of the shellcode. Consequently there is a high possibility of understanding the whole story of the series of the attack, and prevention measures which could not be taken in the conventional antivirus software will be provided.

### Embodiment 2

Although the communication monitoring apparatuses S1 to Sn monitors the communications on the internet N in the first embodiment, the monitoring result in each of the communication monitoring apparatuses S1 to Sn may be summarized for controlling the communications.

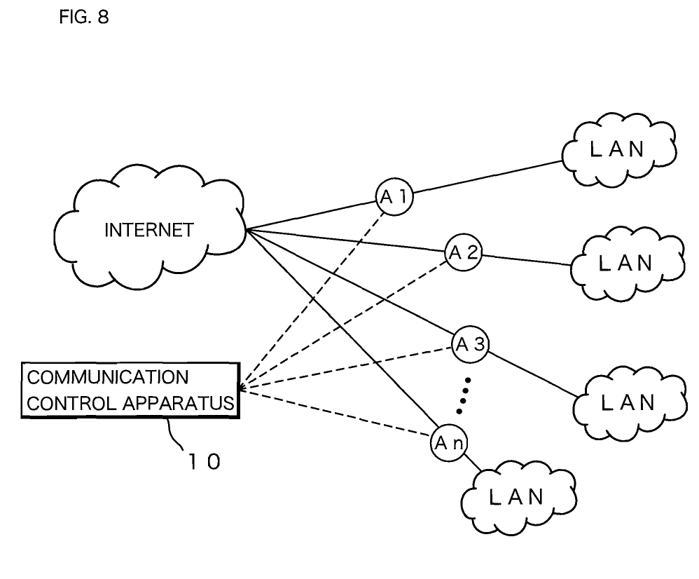

FIG. 8 is an explanatory view explaining a schematic structure of a communication monitoring system according to the second embodiment. The communication monitoring apparatuses A1 to An are provided between a internet and LANs. Each of the communication monitoring apparatuses A1, A2, . . . , An transmits the monitoring result to the communication control apparatus 10.

Each of the communication monitoring apparatuses A1, A2, . . . , An has a IDS mode (IDS: Intrusion Detection System) and a IDP mode (IDP: Intrusion Detection and Prevention). In normal times, the communication monitoring apparatuses A1, A2, . . . , An collect the attack information at the IDS mode, and transmit the results to the communication control apparatus 10.

The communication control apparatus 10 gives an instruction to be shifted to the IDP mode to the appropriate communication monitoring apparatus under circumstances where the attack should be prevented. The communication monitoring apparatus at the IDP mode disconnects the communications including the shellcode and forcefully terminates the connection.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. A communication monitoring system for monitoring communication data which are transmitted among a plurality of nodes on a network, comprising:
a first communication monitoring apparatus; and
a second communication monitoring apparatus; wherein
said first communication monitoring apparatus comprising:
a detecting section for detecting whether or not a shellcode is included in communication data transmitted and received between at least two nodes within the plurality of nodes;
a storing section for storing communication data transmitted from the two nodes as being starting points during a predetermined time, when the detecting section detected the shellcode in communication data; and
a notifying section for notifying information about communication data stored in the storing section to outside;
said second communication monitoring apparatus comprising:
a receiving section for receiving a notification transmitted from said first communication monitoring apparatus;
a determining section for determining whether or not it is necessary to control communications between the two nodes based on the received notification.

2. The communication monitoring system according to claim 1, wherein the information about communication data includes information about the source of the communication data.

3. The communication monitoring system according to claim 1, wherein said second communication monitoring section further comprising a measuring block for measuring a connection frequency between the two nodes; wherein
the determining section determines that it is necessary to control communications between the two nodes, when the measured connection frequency is high.

4. The communication monitoring system according to claim 2, wherein said second communication monitoring section further comprising a measuring block for measuring a connection frequency between the two nodes; wherein
the determining section determines that it is necessary to control communications between the two nodes, when the measured connection frequency is high.

5. A communication monitoring apparatus for monitoring communication data which are transmitted among a plurality of nodes on a network, comprising:
a detecting section for detecting whether or not a shellcode is included in communication data transmitted and received between at least two nodes within the plurality of nodes; and
a storing section for storing communication data transmitted from the two nodes as being starting points during a predetermined time, when the detecting section detected the shellcode in communication data.

6. A communication control apparatus for controlling communications based on communication data transmitted and received on a network, comprising:
a receiving section for receiving information about communications transmitted from a source or a destination of communication data including a shellcode;
a determining section for determining whether or not it is necessary to control communications between the source and the destination based on the received information; and
a controller capable of controlling communications between the source and the destination, when the determining section determines that it is necessary to control communications.

7. The communication control apparatus according to claim 6, further comprising a measuring block for measuring a connection frequency between the source and the destination; wherein
the determining section determines that it is necessary to control communications between the source and destination, when the measured connection frequency is high.
